(19) United States
(12) Patent Application Publication
(10) Pub. No.: US 2018/0240161 A1
(43) Pub. Date: Aug. 23, 2018

(54) SYSTEM AND METHOD FOR NEXT GENERATION THEMEPARK NAVIGATION

(71) Applicant: PANASONIC INTELLECTUAL PROPERTY MANAGEMENT CO., LTD., Osaka (JP)

(72) Inventors: John CRONIN, Bonita Springs, FL (US); Joseph BODKIN, South Burlington, VT (US); Kota MORISAKI, Arlington, VA (US)

(73) Assignee: PANASONIC INTELLECTUAL PROPERTY MANAGEMENT CO., LTD., Osaka (JP)

(21) Appl. No.: 15/438,153

(22) Filed: Feb. 21, 2017

(51) Int. Cl. G06Q 30/02; G06N 5/04; G06Q 10/10; G06Q 30/06; G06Q 10/02

(52) U.S. Cl. CPC G06Q 30/0281; G06N 5/04; G06Q 10/02; G06Q 30/0601; G06Q 10/1093

(57) ABSTRACT

A method for providing holistic wait times of theme park attractions is provided. The method includes acquiring location information of a visitor by identifying a location of a user device accompanying the visitor. Discrete wait times of attractions are received through a theme park network. The discrete wait times are adjusted based on the location information of the visitor to calculate holistic wait times of the attractions. Calculated holistic wait times are provided to the user device.

### BACKGROUND

### 1. Field of the Disclosure

The present disclosure relates to the field of theme park management. More particularly, the present disclosure relates to providing more accurate wait times at various locations at the theme park to provide an improved navigation of a theme park.

### 2. Background Information

In a theme park, various attractions or places of business are available for visitors. Such attractions may include a parade, a show, a particular ride (physical or simulated), and the like. At certain times of the year, the number of visitors visiting the theme park may be larger than usual leading to lengthy wait times. Exposure to such lengthy wait times may impede enjoyment of the theme park experience and the visitors may be unable to visit all of the attractions planned for the visit. Accordingly, the visitors may be less content with the experience and may be less willing to revisit.

To help alleviate lengthy wait times various tip boards have provided throughout the theme park to inform visitors of expected wait times at various attractions or park rides. See FIG. 8. As illustrated in FIG. 8, a tip board typically identifies an attraction and provides an estimate wait times at each of the named attractions. However, the tip board, although placed throughout the theme park at different locations, due to its technical inability to obtain additional information, each of the tip boards may display the same information. For example, if an attraction A is showing a longer estimated wait time but is located closer to the visitor than an attraction B showing a shorter estimated wait time but located further away, the visitor may be better off heading towards the attraction A. However, based on the information provided on the tip board, the visitor may decide to head towards the attraction B. Accordingly, less than accurate information and/or outdated information may be provided by a conventional tip board.

Further, since a conventional tip board is limited in its real estate, it does not typically provide any additional information. For example, a conventional tip board may not indicate in-line entertainment that may be provided for any of the attractions. Further, show times may be displayed without further information. As a result, a visitor may opt to leave an attraction to watch a show only to be informed that the tickets have been previously sold out. Accordingly, the visitors are provided with only a rough idea as to how to plan their trip but nothing they can plan around.

For some tip boards, wait times may be provided in hand written form, which may be updated by one of the theme park employees. Alternatively, the wait times may also be displayed on an electronic display board, which may also be manually updated at discrete time intervals. However, since the wait times are updated at discrete time intervals, the estimated wait times may provide outdated estimates. For example, if a disruption occurs at a particular attraction before the estimated wait times are updated, a visitor may be facing an extended wait time that was unexpected when the estimated wait time information was displayed to the visitor. Accordingly, if a visitor is stuck at an unusually long waiting line for a particular attraction, the visitor may be unwilling to leave the attraction at the risk of incurring similar wait times at other locations not even accounting for travel time expended.

Further, since the wait times are not static and may increase or decrease with time, the estimated wait times may convey less than accurate information. Providing of inaccurate information in turn may lead to lack of reliance by the visitors.

Further, restaurants and cafes located within the theme parks may have independent displays of estimated wait times. However, because the wait times at the restaurants or cafes may be displayed at or near a particular restaurant or café, the visitors may be unable to view the wait times at restaurants prior to arriving at the particular restaurant or café.

### BRIEF DESCRIPTION OF THE DRAWINGS

FIG. 1 shows an exemplary general computer system that includes a set of instructions for electronic routing of information, according to an aspect of the present disclosure;

FIG. 2 shows an exemplary venue with attractions that may be frequented by visitors, according to an aspect of the present disclosure;

FIG. 3 shows an exemplary system for providing next generation navigation, according to an aspect of the present disclosure;

FIG. 4 shows an exemplary process for providing a tip service, according to an aspect of the present disclosure;

FIG. 5 shows an exemplary process for determining a holistic wait time at a target attraction, according to an aspect of the present disclosure;

FIG. 6 shows an exemplary process for providing in-line services for visitors, according to an aspect of the present disclosure;

FIG. 7 shows an exemplary process for managing unusual events, according to an aspect of the present disclosure; and

FIG. 8 shows a conventional tip board provided throughout a theme park.

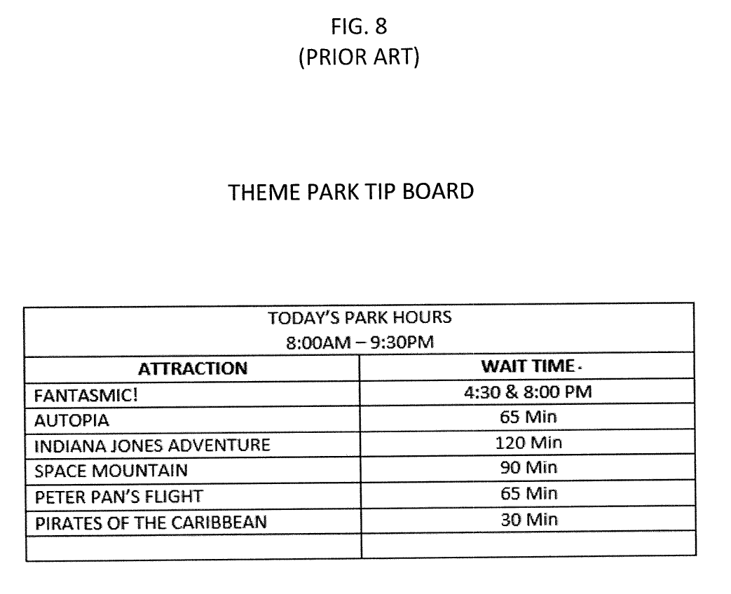

### DETAILED DESCRIPTION

In view of the foregoing, the present disclosure, through one or more of its various aspects, embodiments and/or specific features or sub-components, is thus intended to bring out one or more of the advantages as specifically noted below.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

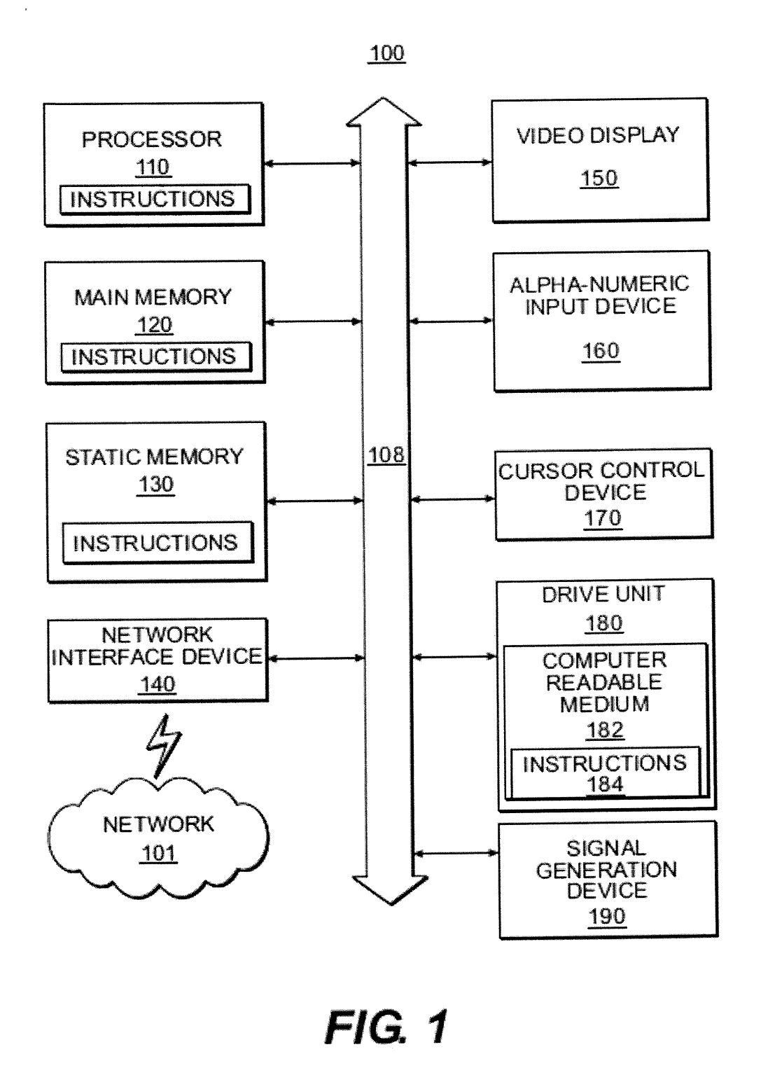

FIG. 1 shows an exemplary general computer system that includes a set of instructions for electronic routing of information, according to an aspect of the present disclosure.

More specifically, FIG. 1 is an illustrative embodiment of a general computer system, on which a method of electronic routing of information can be implemented, and which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system 100 may operate in the capacity of a server or as a client user computer in a server-client user network environment, or as a peer computer system in a peer-to-peer (or distributed) network environment. The computer system 100 can also be implemented as or incorporated into various devices, such as a stationary computer, a mobile computer, a personal computer (PC), a laptop computer, a tablet computer, a wireless smart phone, a set-top box (STB), a personal digital assistant (PDA), a global positioning satellite (GPS) device, a communications device, a control system, a camera, a web appliance, a network router, switch or bridge, virtual reality system, augmented reality system, a sensor, and monitor, or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 includes a processor 110. A processor for a computer system 100 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for a computer system 100 is configured to execute software instructions in order to perform functions as described in the various embodiments herein. A processor for a computer system 100 may be a general purpose processor or may be part of an application specific integrated circuit (ASIC). A processor for a computer system 100 may also be a microprocessor, a microcomputer, a processor chip, a controller, a microcontroller, a digital signal processor (DSP), a state machine, or a programmable logic device. A processor for a computer system 100 may also be a logical circuit, including a programmable gate array (PGA) such as a field programmable gate array (FPGA), or another type of circuit that includes discrete gate and/or transistor logic. A processor for a computer system 100 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the computer system 100 includes a main memory 120 and a static memory 130 that can communicate with each other via a bus 108. Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory described herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted.

As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen or speech input with speech recognition, and a cursor control device 170, such as a mouse or touch-sensitive input screen, pad, augmented reality input device, visual input device, video input device, 3D input device, human eye position input device, haptic input device, body tracking device, acoustic tracking device, or a data glove. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Sets of instructions 184 can be read from the computer-readable medium 182. Further, the instructions 184, when executed by a processor, can be used to perform one or more of the methods and processes as described herein. In a particular embodiment, the instructions 184 may reside completely, or at least partially, within the main memory 120, the static memory 130, and/or within the processor 110 during execution by the computer system 100.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

The present disclosure contemplates a computer-readable medium 182 that includes instructions 184 or receives and executes instructions 184 responsive to a propagated signal; so that a device connected to a network 101 can communicate voice, video or data over the network 101. Further, the instructions 184 may be transmitted or received over the network 101 via the network interface device 140.

The present disclosure employs a distributed architecture to continuously monitor wait times at attractions as well as a visitor's current location. When a wait time at a visitor's intended attraction exceed a pre-determined threshold, the combination of hardware and software components interact to calculate an attraction closest to the present location of the visitor's location and/or route that most closely matches the interests of the visitor. Furthermore, the combination of hardware components may identify an incentive, based upon a stored profile of the visitor that would be most likely to succeed in motivating the visitor to alter their intended route. In doing so, ride condition, wait times, and visitor location are constantly monitored to determine accurate wait times. Thus, an on the fly minimization of visitor wait times may be achieved.

Furthermore, the distributed architecture enables load distribution, reducing congestion and bottlenecks, while still allowing the data to be accessible from a central location.

As a result, venue operators and managers can route visitors away from attractions that the visitors have expressed an interest in visiting when the current estimated wait time is too great, and route the visitors to alternate attractions that match the interests of the visitors but have shorter wait times. Therefore, the overall satisfaction with the experience is increased.

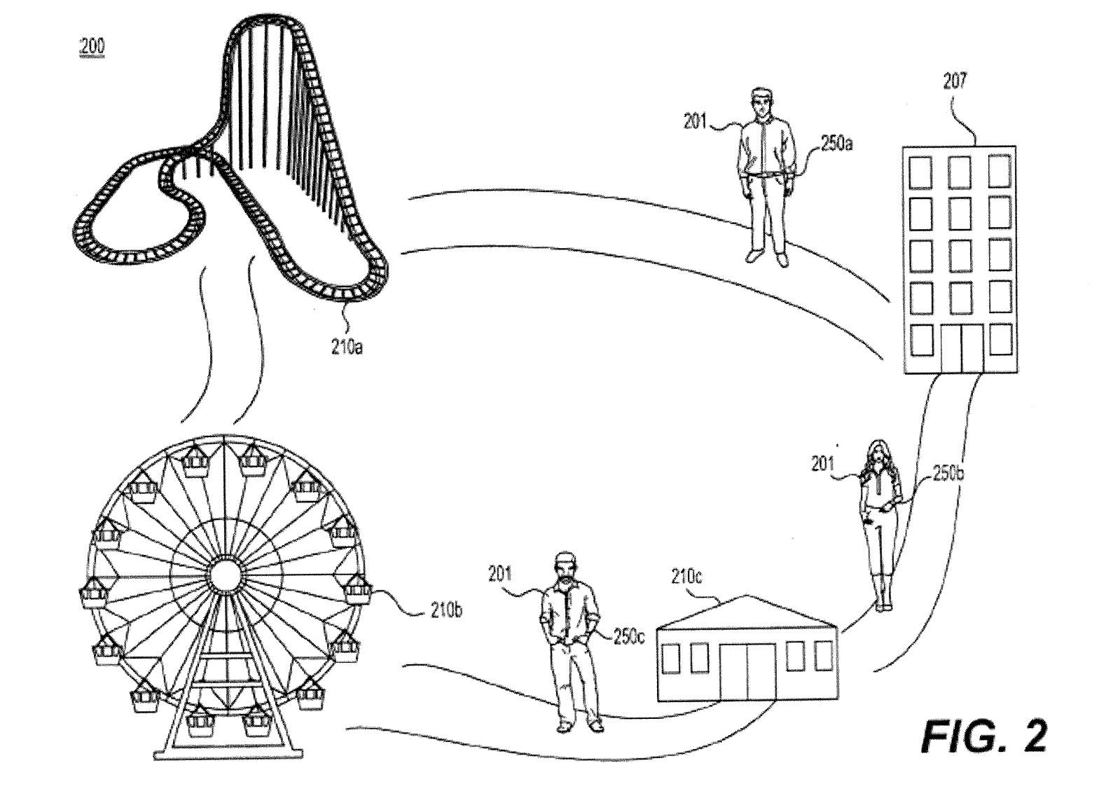

FIG. 2 shows an exemplary venue with attractions that may be frequented by visitors, according to an aspect of the present disclosure.

FIG. 2 is an illustrative embodiment of a venue 200, in which a method of electronic routing of information may be implemented. The method, and various embodiments thereof, may be implemented locally within a predetermined device. On the other hand, some or all of the steps of the method may be implemented on an external network. Exemplary venue 200 includes one or more attractions 210a-c which may be visited by one or more visitors 201. Furthermore, the one or more visitors 202 may wait in lines 203 in order to gain entry to the attractions 201.

In the illustrative embodiment of FIG. 2, the venue 200 includes a plurality of attractions 201 with corresponding wait lines 203. Here, line 203a has less people waiting than line 203b. As can be seen in FIG. 2, line 203a corresponds to attraction 201a, and line 203b corresponds to attraction 201b.

Also shown in FIG. 2 is hotel 207 that includes one or more rooms 208 of various dimensions and shapes to satisfy the preferences of visitors 201. Hotel 207 may be located inside the venue 200 or outside of the venue 200. Venue 200 may refer to any one or more of a resort, hotel, travel destination, theme park, amusement park, hiking park, casino, golf course, museum, campus, or travel destination, for example. In a non-limiting example, the venue 200 may refer to a resort. In an alternative non-limiting example, the venue 200 may refer to a hotel and an amusement park. Specifically, the venue 200 encompasses any facility, location, or place, providing physical boundaries to fulfill one or more objectives of the present disclosure.

Visitors 201 may physically occupy a premise on venue 200 for duration of time. In addition, visitors 201 may directly compensate the operator, or an entity related to the operator, for its services provided to visitors 201. Alternatively, the visitors 201 may not be expected to compensate for services provided them, such as where another entity pays on behalf of the visitor 201 or the visitor 201 does not incur expenses by visiting the venue 200.

The term operator, as used herein, may refer to any entity acting on behalf of the venue 200 who may affect the satisfaction of its visitors 201. For example, an operator may be a travel management company, or alternatively, an operator may be a government entity. A non-exhaustive and exemplary list of operators may include both nonprofit and for-profit entities. In addition to travel management companies, for-profit operators may include entities engaged in earning profits at amusement parks, casinos, museums, resorts, hotels, or other venues. Also, in addition to government entities, nonprofit operators may include educational universities or arts organizations, for example.

A venue 200 includes one or more attractions 210a-c. Each attraction includes at least one visitor 201 waiting in line to experience one or more of the attractions 210a-c. Each of the visitors 201 may wish to access the attractions 210a-c in the venue 200 but may wish to minimize the amount of time waiting in lines. In one embodiment, a listing of holistic wait times may be displayed on a mobile device 250 of the visitors. For example, the listing of holistic wait times may be displayable on a graphical user interface (GUI) of a smartphone or on a GUI of a wearable band, such as a wrist band. The GUI of the mobile device 250 may also permit the visitor to receive incentives, coupons, and offers from the venue operators or other entities within the venue such as vendors. The venue 200 may also include a hotel 207. It is clear that while a number of visitors 201 and attractions 210a-c are shown, the actual number of each is virtually limitless.

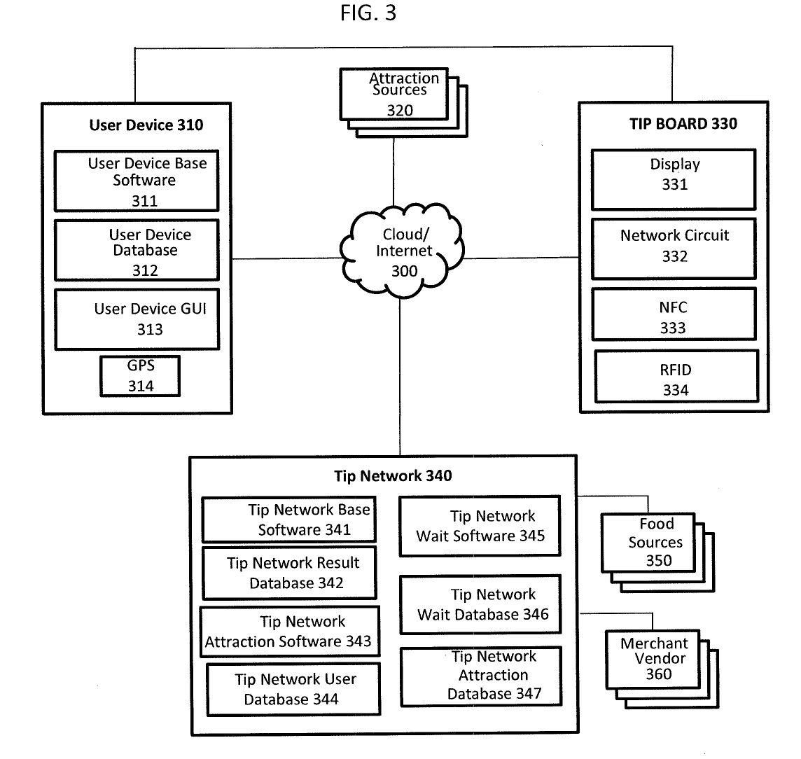

FIG. 3 shows an exemplary system for providing next generation navigation, according to an aspect of the present disclosure.

The exemplary system for providing next generation navigation includes a cloud network 300, a user device 310, attraction sources 320, a next generation tip board 330, a tip network system 340, food sources 350, and merchant vendor sources 360.

A user device 310 may transmit or receive data from at least one of an attraction source database 320, and a tip network 340 via a communication network 300. In an example, the communication network 300 may be a cloud network, cellular network, wireless network or the like.

The user device 310 may include one or more user device base software 311, a user device database 312, a user device GUI 313, and a GPS circuit 314. Further, the user device 310 may operate with an electronic device provided by the theme park. For example, the user device 310 may receive information transmitted by the tip network 340 when the user device 310 is scanned against one or more readers or sensors throughout the theme park. Further, the user device 310 may receive information being pushed by the tip network 340 or the user device 310 may receive information being pulled when the user device 310 requests information from the tip network 340.

Although not explicitly illustrated, the user device 310 may be an electronic communication device having a processor, a memory, one or more transmitters, and one or more receivers. The user device 310 may be configured to receive and transmit various forms of communication, including but not limited to Bluetooth®, RFID, GPS, NFC, Wi-Fi, and/or cellular network. The user device may be a smart phone, a mobile computing device, a wearable electronic device (e.g., fitness level monitoring device). Further, the user device may be an electronic device owned by a visitor or patron to the theme park or an electronic device provided by the theme park.

Attraction sources 320 may be a system of servers. For example, each attraction included in the theme park may have a designated server for collecting information for the respective attraction. The server may be located on-site of the attraction or at a central location. Each of the servers may include a processor, a memory, a transmitter, and a receiver. A server for collecting information of a target attraction may collect information pertaining to, without limitation, number of visitors present in its wait line. The number of visitors entering into its wait line may be determined based on one or more of number of visitors detected as entering through its gates, tickets sold, detection of signals transmitted by user device, detection of movement, imaging technologies, and the like.

The server may also store historical data for the target attraction. For example, the server may store information on average number visiting the target attraction, average wait times for certain days and time of the week, and average time for completing a ride at the target attraction (i.e., throughput rate).

The server may also include regular maintenance schedule, and recordation of unusual incidents occurring at the target attraction.

Based on the number of visitors in the wait line and average throughput rate in view of any scheduled delays (e.g., maintenance) or unexpected delays (e.g., accidents), a discrete or stand-alone wait time may be determined for the target attraction.

The next generation tip board 330 may be an electronic board that may be positioned throughout the theme park. The next generation tip board 330 may include a display 331, a NFC reader 332, an RFID reader 333, and a network circuit 334. The next generation tip board 330 may receive information from various sources through the cloud network 300 or directly by the user device 310. For example, the next generation tip board 330 may receive its location information by having the user device 310 scanned against the NFC reader 332 or the RFID reader 333. Accordingly, the next generation tip board may not be required to be fixed to a specific location and may be movable according to the needs of the theme park. Further, upon receiving additional information from the user device 310, the next generation tip board 330 may provide a more accurate information by providing a wait time of a target attraction in consideration of required travel time, presence of distractions/obstacles (e.g., parades), and other factors.

Further, if the user device is scanned against the NFC reader 332 or the RFID reader 333, an updated wait time may be displayed on the display 332 according to rate of travel speed of the visitor or slowest accompanying member (e.g., a child). Alternatively, the updated wait time may be displayed on the user device 310 only without affecting the display of the next generation tip board 330. The rate of travel speed may be an average travel speed of the child of a certain age, sex and other attributes. Further, the rate of speed may be an actual rate of speed measured by the user device 310. In addition to the more accurate wait times, a listing of in-line entertainment may be provided. The listing of the in-line entertainment may include a movie being displayed in the actual wait line via number of displays positioned throughout the wait line, and/or movies or shows that may be downloaded onto the user device 310.

The tip network 340 may be a network of servers that collect, receive, and transmit various information in the theme park. The tip network 340 may include a tip network base software 341, a tip network result database 342, a tip network attraction software 343, a tip network user database 344, a tip network wait software 345, a tip network wait database 346, and a tip network attraction database 347.

The tip network base software 331 may be software for facilitating the tip network. The tip network base software 331 may be initiated to acquire wait times stored in the tip network wait database 346 and location information of the user device 310. Further, if the user device 310 is determined to be currently at an attraction, estimated wait time of the current attraction may be assigned as a current wait time which may be a basis for comparison with respect to other wait times. The wait times acquired from the tip network wait times may be holistic wait times, which may account for discrete wait times at respective attractions, travel time, travel rate and the like.

The tip network result database 342 may be a database for storing requested comparison inquiries and results of such comparisons. For example, the tip network result database 342 may compile a list of various attractions with corresponding holistic wait times based on a location of the user device, make comparisons between the wait times, identify attractions with lesser wait times, and store identification of such attractions in the tip network result database 342.

Tip network attraction software 343 may be software to acquire a remaining wait time at a current attraction and acquire holistic wait times at other attractions for comparison. The tip network attraction software 343 executes a comparison between the remaining wait time at the current attraction with the holistic wait times at the other attractions to identify alternative attractions that may have shorter holistic wait times.

Tip network user database 344 may be a database that collects and stores information of visitors. For example, when a visitor purchases entry tickets to the theme park for his family, various information of the visitor and his or her family member may be collected for facilitation of services. Information collected may include, without limitation, age, sex, number in party, cell phone information, days at theme park, hotel information and the like.

Tip network wait software 345 may be software to acquire a remaining wait time at a current attraction and acquire holistic wait times at various restaurants or cafes for comparison. The tip network wait software 345 executes a comparison between the remaining wait time at the current attraction with the holistic wait times at the various restaurants or cafes to determine whether stepping out to eat first would be better use of time.

The tip network wait database 346 may collect and manage information pertaining to various restaurants or cafes. Information collected may include, without limitation, location information of a restaurant or cafe, average number of visitors, average wait times, average sit down time, number of occupied tables, unusual activities, promotions or incentives offered, and the like. The tip network wait database 346 may collect such information from various food sources 350.

The tip network attraction database 347 may collect and manage information pertaining to various attractions. Information collected may include, without limitation, location information of an attraction, average number of visitors, average wait times, maintenance schedule, unusual activities, and the like.

The tip network 340 may be connected to food sources 350. The food sources 350 may be a system of servers. For example, each restaurant/cafe included in the theme park may have a designated server for collecting information for the respective restaurant/cafe. The server may be located on-site of the restaurant/café, a hub location, or at a central location. Each of the servers may include a processor, a memory, a transmitter, and a receiver. A server for collecting information of restaurant/cafe may collect information pertaining to, without limitation, a number of visitors currently waiting, a number of tables vacant, occupancy time for each of the occupied dining spaces or tables, and other related information. The server may also include average dining time per table basis to determine estimated capacity and discrete or stand-alone wait time.

The tip network 340 may be additionally connected to merchant vendor sources 360. The merchant vendor sources 360 may be a system of servers. For example, each merchant vendor included in the theme park may have a designated server for servicing the visitors of the theme park. The server may be located on-site of the merchant vendor, a hub location, or at a central location. Each of the servers may include a processor, a memory, a transmitter, and a receiver. A server for servicing the visitors may be configured to take online purchase orders during their trip through the park. The server may collect order information, payment information, requested delivery location and time, pick-up location and time, hotel information and the like. For example, the merchant vendor may provide a free delivery service to deliver purchased goods to a specified or designated pick-up location, such as an exit point of an attraction, an exit point of the theme park, or at a hotel lobby of the visitor.

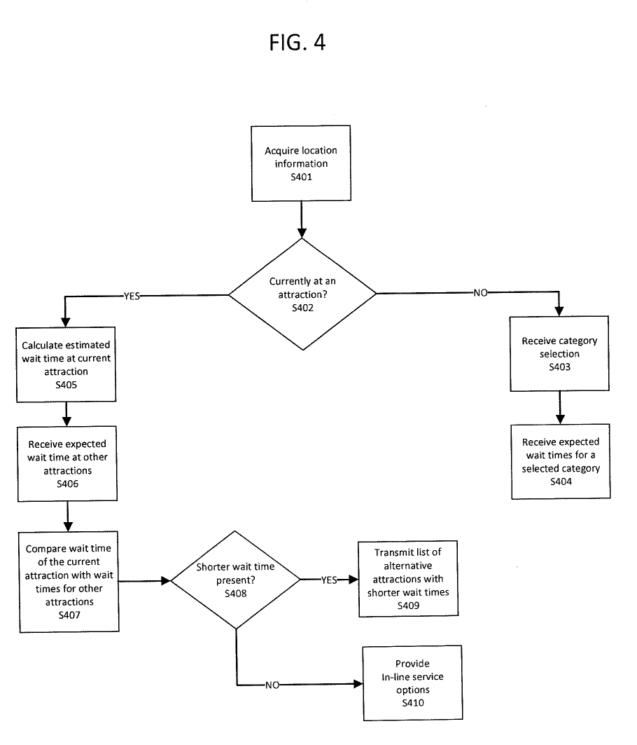

FIG. 4 shows an exemplary process for providing a tip service, according to an aspect of the present disclosure.

In FIG. 4, location data of a user terminal is acquired in S401. In an example, when a visitor visits a theme park, a user device of the visitor may be registered to a tip network. In a non-limiting example, the user device registered may include a mobile device, such as a smart phone, a personal electronic device, a wearable device, and any other electronic device having one or more of a processor, a transmitter or a receiver. Further, the visitor may opt to register his or her own device to the tip network or be provided with a device by the theme park.

Also, in a non-limiting example, the location data of the user terminal may be GPS data, triangulation location data provided by a cell network, or discrete location data provided by scanning or sensing the user device. For example, if the visitor scans the user device to obtain entry to a particular attraction, the user's device's location may be determined.

In S402, a determination is made by a computer in the tip network whether the user device is at an attraction based on the acquired location data. In a non-limiting example, if the computer determines that the visitor is within a predetermined distance from the attraction, the computer may determine that the user device is at the attraction. For example, if the user device is near an entrance of the attraction, the computer may determine that the user device is at the attraction. Alternatively, the computer may be set to determine that the user is at the attraction when the user device has passed an entrance of the attraction.

If the user device is determined not to be at the attraction in S402, the method will proceed to S403. In S403, a selection of a category of sites of interest is made. For example, categories for selection may include attractions, shows, restaurants/café, and merchants.

In S404, the expected wait times for the selected category are received at the user device from the tip network. In a non-limiting example, expected wait times may be received for sites of interest according to a category selected by the visitor, sites of interest located within a predetermined distance, sites of interest preselected by the visitor, sites of interest that have not yet been visited by the visitor, and the like.

Further, in S404, the expected wait times received will include both a calculated estimated wait time of a site of interest and an estimated travel time from the location of the user device to the respective site of interest. For example, if an estimated wait time for a particular roller coaster ride is determined to be 30 minutes, and an estimated travel time of the visitor from the attraction to the roller coaster ride is determined to be 15 minutes, an expected wait time of 45 minutes for the roller coaster ride may be presented to the user device.

In addition, the expected wait time may be adjusted to account for additional visitors getting in line at the roller coaster ride during the travel time of the visitor based on historical data. For example, if it is known that number of visitors getting in line for the roller coaster ride grows at a rate of 2 people per minute, the expected wait time may be adjusted accordingly to provide the visitor a more accurate estimated wait time.

Further, in a non-limiting example, the expected wait times received may additionally be adjusted with respect to time of arrival according to historical data. For example, if an expected arrival time of the visitor to the roller coaster ride from the attraction is determined to be near dinner time, it may be determined that no additional visitors may be getting in line to ride the roller coaster ride, such that shorter wait time may be provided at the time the visitor arrives at the roller coaster ride.

If the user device is determined to be at the attractions in S402, the computer in the tip network will calculate an estimated wait time at the respective attraction in S405. In a non-limiting example, the wait time may be calculated based on a determination of how many visitors are in queue for the attraction. A size of the queue may be determined based on location data of the user devices, a detection of entry by a sensor at an entrance of the attraction, and any other available technology. Further, the estimated wait time may also factor in additional circumstances that may be present at the attraction, such as expected/unexpected maintenance, cleanup, delays or stoppage due to safety concerns, and the like. Once the estimated wait time at the respective attraction is calculated in S405, the method will proceed to S406.

In S406, expected wait times at other attractions are received at the user device from the tip network. In a non-limiting example, expected wait times may be received for attractions within a predetermined distance from the current attraction. However, aspects of the present disclosure are not limited thereto, such that the visitor may request to receive wait times for restaurants or shows instead.

Further, in S406, the expected wait times received will include both a calculated estimated wait time of a target attraction and an estimated travel time from the location of the user device to the target attraction. For example, if an estimated wait time for the target attraction is determined to be 30 minutes, and an estimated travel time of the visitor from the current attraction to the target attraction is determined to be 15 minutes, an expected wait time of 45 minutes for the target attraction may be presented to the user device.

In addition, the expected wait time may be adjusted to account for a potential increase or decrease in the wait time during the travel time of the visitor based on historical data. For example, if it is known that number of visitors getting in line for the target attraction grows at a rate of 3 people per minute, the expected wait time may be adjusted accordingly to provide the visitor a more accurate estimated wait time. Similarly, if an expected arrival time of the visitor to the target attraction from the current attraction is determined to be near dinner time, it may be determined that no additional visitors may be getting in line for the target attraction, such that shorter wait time may be provided at the time the visitor arrives at the target attraction.

After the expected wait times at other sites of interest are received in S406, a comparison is made between the wait time at the current attraction and received estimated wait times for alternative attractions at S407.

In S408, if it is determined that shorter wait times are available at the alternative attractions, a list of alternative attractions having shorter wait times are transmitted to the user device for display in S409.

In S410, a list of entertainment options is transmitted to the user device. However, aspects of the present disclosure are not limited thereto, such that other in-line services may be available to the visitor in the wait line. Other in-line services may include procurement of souvenirs, making reservations to shows or restaurants and the like.

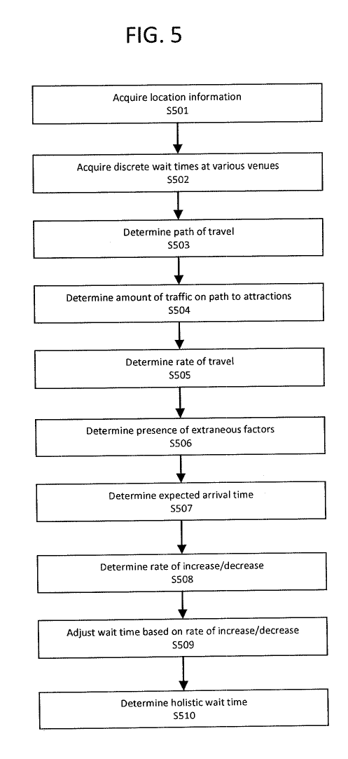

FIG. 5 shows an exemplary process for determining a holistic wait time at a target attraction, according to an aspect of the present disclosure.

At S501, location information of the user device may be acquired. Location information of the user device may be acquired by a GPS signal, triangulation of cellular signals, or any other location identification technology. Further, location information of the visitor may be acquired based detection of a radio or NFC signal transmitted by an electronic device provided to the visitor by the theme park. For example, a theme park may issue an electronic band that is capable of transmitting a passive radio or NFC signal to the visitor. When the visitor wearing such an electronic band transmits a signal at various locations to obtain information or access throughout the park, the location information of the visitor may be acquired. For example, the visitor may scan his or her electronic band at one of the tip display boards located throughout the theme park to obtain tip information.

At S502, discrete wait times are acquired at various venues. In an example, a discrete wait time may be an expected wait time at a particular ride, show, or a ride a visitor may incur if the visitor was present at the venue. Discrete wait times may be acquired for venues located within a reference distance from a location of the visitor or according to a category selected by the visitor. For example, if the visitor sets a filter to receive wait times for roller coasters, only wait times for the roller coasters may be provided. Similarly, if the visitor sets the filter to receive wait times for restaurants within 50 yards of the visitor, wait times for restaurants meeting the specified criteria may be provided. Further, additional filters may be applied to limit an amount of data to be acquired by the user device.

A discrete wait time may be calculated based on number of passengers present at its waiting line in view of rate of throughput. For example, the number of visitors may be determined based on a detection of visitors passing through an entry gate of the waiting line, detection of GPS signals, sensing information provided by various sensors present at the waiting line or the like. Further, discrete wait times may also be calculated in consideration of any maintenance or outages.

In S503, paths of travel, from the location of the visitor to the venues for which wait times are acquired, are determined. In an example, one or more paths may be provided for each of the venues based on distance or time of travel. Further, paths for avoiding certain events or shows may be provided as alternate paths in case the visitor seeks to avoid a path that may distract an accompanying child.

In S504, a determination of amount of foot traffic is made for each of the identified paths. In an example, an amount of foot traffic present in each of the paths is determined based on location information of visitors. Further, the amount of foot traffic present may be determined based on movement detected by various sensors or beacons located throughout the theme park. In another example, the amount of foot traffic present may be determined based on historical data. However, aspects of the present disclosure are not limited thereto, such that the amount of foot traffic may be determined according to other available technologies.

In S505, a determination of rate of travel is determined. More specifically, the rate of travel may be determined based on a composition of a traveling party. For example, a traveling party may include two adults and two children. Based on the composition of the traveling party, rate of travel may be determined for the slowest traveler included in the traveling party. For example, the slowest traveling member may be a child. Accordingly, even if the user device may be operated by an adult included in the traveling party, the rate of travel may be determined based on the traveling speed of the child. The rate of travel may be determined based on average speed determined based on age, sex, and/or other attributes. Further, a rate of travel may be monitored upon entry into the theme park and be used to adjust the average rate of travel initially assigned to the traveling party.

In S506, a determination of presence of extraneous factors is made. For example, extraneous factors may include, without limitation, certain weather conditions, street shows or parades scheduled during time of travel to the target venues, and incidents (e.g., accidents, maintenance, or etc.) present in the paths of travel during the time of travel to the target venues.

In S507, a determination of expected arrival time or travel time to get to the target venues is calculated for each of the paths of travel. The expected arrival time may be calculated in view of previous information acquired in one or more of S501, S502, S503, S504, S505 and S506.

In S508, a rate of increase or decrease of the discrete wait time acquired in S502 is determined. The rate of increase or decrease of the discrete wait times may be based on historical data. For example, historical data of target venue A may indicate that wait times grows at a rate of 2 persons per minute during the time of travel (e.g., 2:00 PM to 2:14 PM) estimated for the visitor. Accordingly, in this example, the wait time may be longer than the originally indicated discrete wait time acquired in S502 by the time the visitor arrives at the target venue A.

In S509, the wait times at the target venues are adjusted according to the determine rate of increase or decrease in the wait times in S508. For example, if the rate of increase for the target venue A is 2 persons per minute and expected time of travel from a current location of the visitor to the target venue A is 14 minutes, it is expected that net 28 additional visitors have been added to the wait line by the time the visitor arrives at the target venue A. Further, if historical data indicates that 1 minute is added for every visitor that is added to the wait line, it may be determined that 28 additional minutes should be added to the discrete wait time to determine an expected wait time at the time of arrival at the target venue A.

In S509, the adjusted wait times determined in S508 is added with the estimated travel time determined in S507 to provide a total expected wait time at the target venues. Accordingly, the visitor may be provided with more accurate wait times at various venues from a location of the visitor. Visitors having access to such information may plan their trip through the park with increased efficiency with reduced wait times.

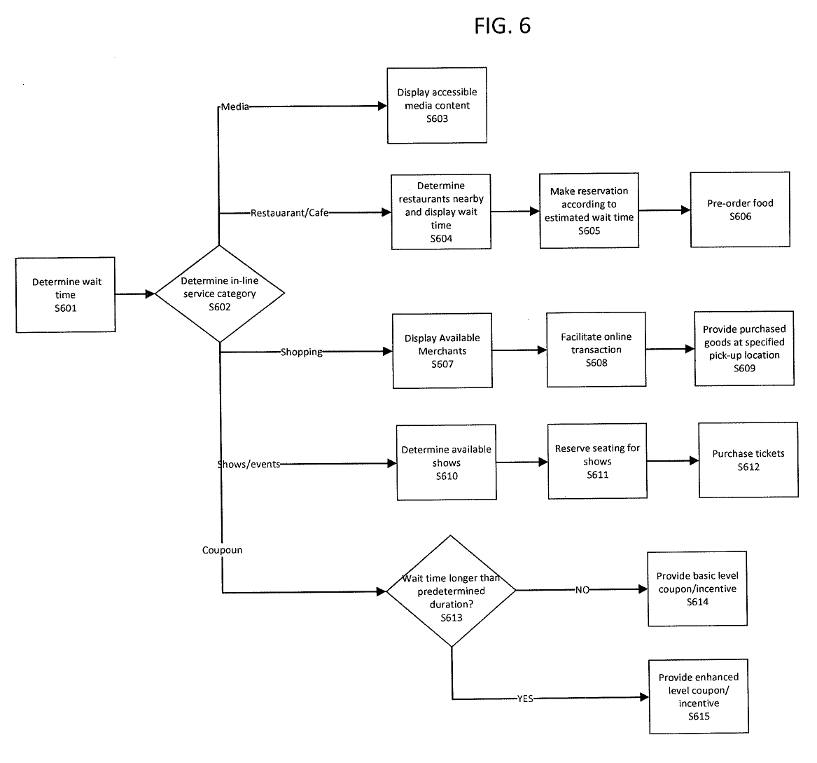

FIG. 6 shows an exemplary process for providing in-line services for visitors, according to an aspect of the present disclosure.

In S601, wait time is determined for a current venue. In S602, categories of in-line services are displayed to the visitor in the wait line. Categories of selection may include access to entertainment, facilitation of a network transaction, dining reservation, event/show reservation and access to incentives or coupons. However, aspects of the present disclosure are not limited thereto, such that other categories of in-line services may be available.

If the access to entertainment is selected is S602, a list of accessible media content is displayed in S603. The media content selected may be accessed by streamlining or download with its license expiring at a designated time (e.g., within 24 hours). The list of accessible media content may be based on a location of the visitor, length of the wait, or other criteria. For example, if the location information indicates that the visitor is at venue A, then list of movies related to the venue A may be provided for selection. Further, if the wait time is determined to be relatively short, shorter or older media content may be provided for selection without incurring a fee. However, if the wait time is determined to be lengthy, recently released or premium content may be available for selection. In addition, an option to keep the downloaded copy of the media content may be provided if the wait time is determined to be unusually lengthy, for example, due to mechanical failures. Alternatively to the above, the list of accessible media content may be the same without condition.

If dining reservation or dining is selected in S602, a determination of nearby restaurants may be displayed according to the location of the visitor in S604. For example, only restaurants within a predetermined distance from an exit point of the current venue of the visitor may be displayed. However, the visitor may have an option to view all available restaurants, if desired. Further, the restaurants may be displayed according to a type of food (e.g., Italian vs. American), type of restaurant (e.g., take out or seat down), rating, and the like. Wait times are further provided for the displayed restaurant.

In S605, a request for reservation is made by the visitor on the user device for a chosen restaurant and a reservation request is transmitted to the selected restaurant. The reservation request may be based on the estimated wait line at the venue. For example, if the estimated wait line is indicated as being 20 minutes, a ride provided by the venue is 5 minutes, and travel time to the restaurant is another 5 minutes, it may be determined that the reservation may be set for 30 minutes in the future. However, aspects of the present disclosure are not limited thereto, such that the reservation set may be dynamically updated if the wait time at the current venue is changed.

Further, in S606, certain restaurants may further provide an option to pre-order food for quicker service to further save time for the visitors. For example, if the reservation is set for 30 minutes, an order may be queued to be transmitted from the user device 10 minutes prior to arriving at the reserved restaurant. Although making of the reservation and pre-ordering of food are illustrated as two separate operations, aspects of the present disclosure are not limited thereto, such that pre-ordering of food may be performed without first making a reservation.

If facilitation of a network transaction or shopping is selected in S602, available merchants located at the theme park may be displayed in S607. For example, various gift shops selling theme park souvenirs may be displayed. The available merchants may be filtered according to a distance, based on promotions being provided, delivery options, payment options and the like.

Once the visitor makes a selection of the merchant, the visitor may select goods for purchase and facilitate an online payment transaction for securement of the selected goods in S608. As a part of the online transaction, the visitor may be able to specify a location for pick up. For example, the purchased goods may be picked up at the exit point of the venue, exit point of the theme park, at a hotel, and the like.

In S609, the purchased goods are delivered to the specified pick-up location.

If event/show reservation is selected in S602, a determination of available shows is determined in S610. In an example, the availability of shows may be determined based on the wait time at the current venue, expected travel time to the venue and the like. The shows to be displayed may be further filtered according to various selections, such as genre, age appropriateness, costs, and the like.

Once a show is selected, the visitor may reserve a seating in S611. Since the visitor may wish to sit as a group with his/or her companions (e.g., family members), seating availability may be displayed to the visitor prior to requiring purchase of tickets. Once the seats have been reserved in S611, the visitor may purchase the tickets to the selected show in S612.

If access to incentives or coupons is selected in S602, a determination of whether the current wait time is longer than a predetermined duration is made in S613. If it is determined that the current wait time is less than the predetermined duration, basic level coupon/incentive may be provided in S614. For example, since many cafes or shops may be competing for business, various shops may be motivated to provide coupons for potential patrons to increase sales. Alternatively, if it is determined that the current wait time is longer than predetermined duration, enhanced level coupon/incentive may be provided in S615. For example, if the visitor is subject to an abnormally long wait time due to a machine malfunction, enjoyment and satisfaction of the theme park may be adverse. Accordingly, to alleviate dissatisfaction, enhanced level of coupons or incentives may be provided to the affected visitors. In an example, the theme park may offer to subsidize a meal at a nearby restaurant or café or heavily discounted or free tickets to shows/events that may not otherwise be filled to capacity and the like.

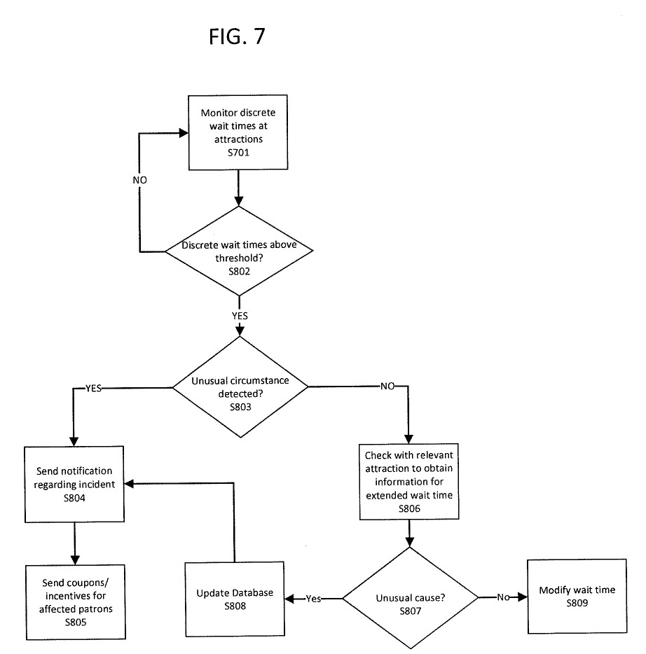

FIG. 7 shows an exemplary process for managing unusual events, according to an aspect of the present disclosure.

In S701, stand-alone or discrete wait times of each venue are monitored for unusual activity. For example, if each of the venues are showing a wait time of 30 minutes or less while one venue is showing a wait time greater than 50 minutes, the venue showing the wait time of greater than 50 minutes may be determined as an unusual activity.

In S702, a determination of whether the discrete wait times are greater than a predetermined threshold is made. The predetermined threshold may be a fixed value or a dynamically adjusted value. For example, 30 minutes may be determined to an average wait time for venue A, but during holidays, 50 minutes may be determined to be an average wait time. The predetermined threshold may be the average wait time with an added buffer time.

If it is determined in S702 that the discrete wait times are below the predetermined threshold in S702, monitoring of stand-alone or discrete wait times is continued in S701.

Alternatively, if it is determined in S702 that the discrete wait time is above the predetermined threshold, a determination of whether an unusual circumstance has been detected is made in S703. For example, the unusual circumstance may include an accident, unscheduled maintenance, criminal activity, and the like. The determination may be made by inquiring a database within a tip network, which may be a central repository of incidents occurring the in the theme park.

If it is determined that the unusual circumstance has been detected in S703, a notification is transmitted to affected visitors, visitors within a predetermined distance from the affected venue, or all visitors. For example, if it is a maintenance issue that is expected to be resolved within a short duration, the notification may be limited to the affected visitors only. However, if it is due to a more sever mechanical failure requiring hours or work, the notification may be transmitted to all visitors to avoid unnecessary wait times.

In S705, special coupons or incentives may be additionally transmitted to the affected visitors. Further, different levels of coupons or incentives may be provided based on amount of detriment caused to the affected visitors. For example, a visitor who waited over an hour before being notified may receive a greater incentive than a visitor who only waited 10 minutes.

If it is determined that the unusual circumstance has not been detected in S703, a check is made with the affected venue to obtain information to determine cause of the extended wait time in S706. If it is determined that there is a legitimate cause for the extended wait time in S707, the database in the tip network may be updated with the cause for the extended wait time in S708 and corresponding notification may be sent to relevant visitors in S704. Further, the affected visitors may receive coupons or incentives in S705.

If it is determined that there is no legitimate cause for the extended wait time in S707, the wait time is updated to reflect the extended wait time in S709.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

As described above, according to an aspect of the present disclosure, a method is provided for providing holistic wait times of theme park attractions. The method includes acquiring location information of a visitor by identifying a location of a user device accompanying the visitor. Discrete wait times of attractions are received through a theme park network. The discrete wait times are adjusted based on the location information of the visitor to calculate holistic wait times of the attractions. Calculated holistic wait times are provided to the user device.

According to another aspect of the present disclosure, the method further includes determining whether the visitor is currently at an attraction based on the location information; when the visitor is determined to be currently at the attraction, comparing the wait time of a current attraction with the holistic wait times of other attractions; when the wait time of the current attraction is determined to be longer than one or more of the holistic wait times of other attractions, providing a list of other attractions with the holistic wait times shorter than the current attraction; and when the wait time of the current attraction is determined to be the shorter than the holistic wait times of the other attractions, providing in-line options.

According to yet another aspect of the present disclosure, the in-line options include a schedule of in-line movies displayed on displays provided throughout a waiting line of the current attraction.

According to still another aspect of the present disclosure, the in-line options include an option to access digital content via the user device.

According to another aspect of the present disclosure, the in-line options include an in-line shopping options.

According to yet another aspect of the present disclosure, the in-line shopping specifies a location for receiving goods.

According to still another aspect of the present disclosure, the in-line options include reserving a ticket to a show.

According to another aspect of the present disclosure, the in-line options include reserving a table at a restaurant.

According to yet another aspect of the present disclosure, a reservation time is adjusted in accordance with an adjustment in the wait time at the current attraction.

According to still another aspect of the present disclosure, the method further includes determining whether the visitor is currently at an attraction based on the location information; when the visitor is determined to be currently at the attraction, obtaining holistic wait times at restaurants within a predetermined distance of the visitor; comparing the wait time of the attraction with the holistic wait times of the restaurants; when the wait time of the current attractions is determined to be longer than one or more of the holistic wait times of the restaurants, providing a list of restaurants with shorter holistic wait times; and when the wait time of the current attraction is determined to be the shorter than the holistic wait times of the restaurants, providing in-line options.

According to another aspect of the present disclosure, the method further includes providing incentives if the wait time is determined to be longer than a predetermined duration.

According to yet another aspect of the present disclosure, the method further includes receiving, at the user device, a selection of category of attractions, the holistic wait times of the attractions corresponding to the selected category are provided.

According to still another aspect of the present disclosure, the category of attraction includes a restaurant, a café, a show, an event, and a type of ride.

According to another aspect of the present disclosure, the discrete wait times are adjusted based on estimated travel time from current location to each one of the attractions.

According to yet another aspect of the present disclosure, the estimated travel time is based on estimated travel speed of slowest member accompanying the visitor.

According to still another aspect of the present disclosure, the estimated travel time is based on presence of attraction events in a path of travel from the current location to each of the attractions.

According to another aspect of the present disclosure, the estimated travel time is based on an incident on a path of travel.

According to yet another aspect of the present disclosure, the discrete wait times are adjusted based on estimated rate of growth of line based on estimated arrival time and historical data.

According to an aspect of the present disclosure, a tangible computer readable storage medium stores a computer program. The computer program, when executed by a processor, causes a computer apparatus to perform a process. The process includes acquiring, for storage in the computer apparatus, location information of a visitor; transmitting, to a network, the location information; receiving, from the network, discrete wait times of attractions; calculating holistic wait times of the attractions by adjusting the discrete wait times in accordance with the location information of the visitor; and providing, to the computer apparatus, the holistic wait times of the attractions.

According to an aspect of the present disclosure, a computer apparatus includes a memory that stores instructions, and a processor that executes the instructions. When executed by the processor, the instructions cause the processor to perform operations. The operations include acquiring location information of a visitor; transmitting, to a network, the location information; receiving, from the network, discrete wait times of attractions; calculating holistic wait times of the attractions by adjusting the discrete wait times in accordance with the location information of the visitor; and providing the holistic wait times of the attractions.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing holistic wait times of theme park attractions, the method comprising:
acquiring, for storage in a user device, location information of a visitor;
transmitting, to a network, the location information;
receiving, from the network, discrete wait times of attractions;
calculating holistic wait times of the attractions by adjusting the discrete wait times in accordance with the location information of the visitor; and
providing, to the user device, the holistic wait times of the attractions.

2. The method of claim 1, further comprising:
determining whether the visitor is currently at an attraction based on the location information;
when the visitor is determined to be currently at the attraction, comparing the wait time of a current attraction with the holistic wait times of other attractions;
when the wait time of the current attraction is determined to be longer than one or more of the holistic wait times of other attractions, providing a list of other attractions with the holistic wait times shorter than the current attraction; and
when the wait time of the current attraction is determined to be the shorter than the holistic wait times of the other attractions, providing in-line options.

3. The method of claim 2, wherein the in-line options include a schedule of in-line movies displayed on displays provided throughout a waiting line of the current attraction.

4. The method of claim 2, wherein the in-line options include an option to access digital content via the user device.

5. The method of claim 2, wherein the in-line options include an in-line shopping options.

6. The method of claim 5, wherein the in-line shopping specifies a location for receiving goods.

7. The method of claim 2, wherein the in-line options include reserving a ticket to a show.

8. The method of claim 2, wherein the in-line options include reserving a table at a restaurant.

9. The method of claim 8, wherein a reservation time is adjusted in accordance with an adjustment in the wait time at the current attraction.

10. The method of claim 1, further comprising:
determining whether the visitor is currently at an attraction based on the location information;
when the visitor is determined to be currently at the attraction, obtaining holistic wait times at restaurants within a predetermined distance of the visitor;
comparing the wait time of the attraction with the holistic wait times of the restaurants;
when the wait time of the current attractions is determined to be longer than one or more of the holistic wait times of the restaurants, providing a list of restaurants with shorter holistic wait times; and
when the wait time of the current attraction is determined to be the shorter than the holistic wait times of the restaurants, providing in-line options.

11. The method of claim 1, further comprising:
providing incentives if the wait time is determined to be longer than a predetermined duration.

12. The method of claim 1, further comprising:
receiving, at the user device, a selection of category of attractions, wherein
the holistic wait times of the attractions corresponding to the selected category are provided.

13. The method of claim 12, wherein:
the category of attraction includes a restaurant, a café, a show, an event, and a type of ride.

14. The method of claim 1, wherein
the discrete wait times are adjusted based on estimated travel time from current location to each one of the attractions.

15. The method of claim 14, wherein
the estimated travel time is based on estimated travel speed of slowest member accompanying the visitor.

16. The method of claim 14, wherein
the estimated travel time is based on presence of attraction events in a path of travel from the current location to each of the attractions.

17. The method of claim 14, wherein
the estimated travel time is based on an incident on a path of travel.

18. The method of claim 1, wherein
the discrete wait times are adjusted based on estimated rate of growth of line based on estimated arrival time and historical data.

19. A tangible computer readable storage medium that stores a computer program, the computer program, when executed by a processor, causing a computer apparatus to perform a process comprising:
acquiring, for storage in the computer apparatus, location information of a visitor;
transmitting, to a network, the location information;
receiving, from the network, discrete wait times of attractions;
calculating holistic wait times of the attractions by adjusting the discrete wait times in accordance with the location information of the visitor; and
providing, to the computer apparatus, the holistic wait times of the attractions.

20. A computer apparatus, comprising:
a memory that stores instructions, and
a processor that executes the instructions,
wherein, when executed by the processor, the instructions cause the processor to perform operations comprising:
acquiring location information of a visitor;
transmitting, to a network, the location information;
receiving, from the network, discrete wait times of attractions;
calculating holistic wait times of the attractions by adjusting the discrete wait times in accordance with the location information of the visitor; and
providing the holistic wait times of the attractions.
